(19) United States
(12) Patent Application Publication
(10) Pub. No.: US 2003/0130884 A1
(43) Pub. Date: Jul. 10, 2003

(54) Strategic business planning method

(76) Inventor: Gerald Michaluk, Glasgow (GB)

Correspondence Address: GERALD MICHALUK, 100 WELLINGTON STREET, GLASGOW, G2 6DH, GB

(21) Appl. No.: 10/041,397

(22) Filed: Jan. 9, 2002

(51) Int. Cl. G06F 17/60

(52) U.S. Cl. 705/11

(57) ABSTRACT

A strategic planning method that comprises monitoring a business strategy (10); monitoring an operational action plan (12); monitoring real-time critical assumptions (16); monitoring staff performance (20) and reviewing each of the monitored business strategy (10); operational action plan (12); real-time critical assumptions (16) and staff performance (20). In the event that the step of reviewing indicates any change, this is assessed during a STORM meeting and one or more of the business strategy (10); the operational action plan (12); the real-time critical assumptions (16) and staff performance (20) is up-dated.

### BACKGROUND OF THE INVENTION

The present invention relates to a method for strategic business planning.

Strategic planning and specifically, long term planning, is an important and complex area of business activity. It has moved in and out of favour over the years, while the development cycle has continuously condensed. It has been said there is no effective means of predicting the future and therefore it is not worth the effort to do so. On the other hand it is also said that because of the speed of change in today's markets, there is more need than ever to undertake strategic and long term planning.

The arguments for and against strategic planning are outlined in a great many books for example Mintzberg's “The Rise and Fall of Strategic Planning”, and Michael de Kare-Silver's “Strategy in Crisis”. Both outline why strategic planning, and in particular, long-range planning have been ignored by managers and warn of the consequences.

Michael de Kare-Silver reports in his book that Chief Executives and even corporate planning Vice Presidents have a variety of definitions for strategy, for example “It is a combination of the ends for which the firm is striving and the means by which it is seeking to get there”. A rather more simplistic definition is “Planning is the process of discovery of what is required to be done in order to achieve a specific goal”. The variety of even basic definitions of what is meant by strategy is indicative of the complexity of the field and the range of approaches taken.

Mintzberg's work clearly describes the dangers in strategic planning. Mintzberg writes about how if badly managed, the strategic planning process itself could undermine commitment, create myopia, destroy innovation, and generate a Machiavellian atmosphere of politics and intrigue. All of these damage shareholder value and can destroy the company's ability to be managed effectively. Therefore, there are good reasons to be cautious and extremely careful in the strategic planning process. This is why some firms have given up. Some firms have, however, gone to the opposite extreme. Bain & Co, the strategic consultants, has reported that at any one time as many as 11 major management approaches were being implemented simultaneously within a single company. Constant change of this nature can create a feeling of apathy towards new initiatives, which is a disadvantage.

There are a wide range of strategic planning tools available to help formulate strategy and prepare plans, for example: Arthur D Little's “Life Cycle Matrix”; the Boston Consultancy Group's “Growth Share Matrix”; Citicorp's “Interaction Analysis”; Dow-Corning's “Strategy Matrix”; General Electric's “Matrix”; Harrigan-Porter's “End-Game Analysis”; King's “Strategic-issue Analysis”; the “Orchard Matrix of Market Attractiveness”; Porter's “Value Chain Analysis” and “Real Options”.

One approach that has been widely adopted by many of the worlds largest companies is the Balanced Scorecard approach, which was developed by Kaplan and Norton. Software to support its deployment has been developed and is widely available. FIG. 1 shows a diagrammatic representation of the Balanced Scorecard model, as applied to a hi-tech company. It involves the strategy being viewed from four different perspectives, namely, the financial, the customer, the internal and learning and growth.

The ultimate objective of the financial view of the Balanced Scorecard is to “improve shareholder value”. Improved shareholder value comes as a consequence of the offsetting of income growth against increased productivity within the company. The factors of income growth and productivity both consist of two main subsections. Within income growth, the contributing factors are the expansion of the market and the increasing of income from the present client base. The two factors that lead to increased productivity are increased efficiency and better use of current resources combined with large investments being replaced by gradual investments.

As regards the customer perspective, Kaplan and Norton describe this section as “the heart of the strategy”. This area outlines the exact strategy for gaining new custom or for enlarging the current customers' division of business. The internal perspective outlines the corporate processes and exact actions that company must perfect in order to maintain the customer view.

The learning and growth perspective has three main sections. The first is that of strategic capabilities. This section encapsulates the knowledge and abilities demanded from the staff in order to maintain the strategy. The second section is that of “strategic technologies” (Norton & Kaplan 2001: 93). This part is concerned with the technological requirements that are necessary to maintain the strategy. The third and final area is that of environment for activity. Within this part the effect of shifts in the social atmosphere of the organisation are taken into account as the optimum environment in which to maintain the strategy is examined.

Other strategy approaches rely heavily on so-called real time data. Regis McKenna outlines the need to utilise real-time data in his book, “Real Time: Preparing for the age of the never satisfied customer”. Real-time data has, however, its limitations. The problems arise from two sources: reliability and volume.

As will be appreciated, data is not always reliable. If data is taken in real-time then there is a danger of it being accepted as fact when it is actually fiction, particularly if data collection is incomplete. Therefore, while data can be collected in real-time it is most effectively judged in combination with other sources, some of which are likely not to be available in real-time.

Managers subjected to real-time data feeds quickly stop looking at the data, often because of its questionable reliability, but more often because of the sheer volume of data that can be gathered. There is no effective filter process to sift out erroneous, incomplete or irrelevant data. Thus, managers get swamped with data that they cannot use at that time, and the sheer volume makes it difficult to find if needed at a later date. This is an on-going problem in the business world.

Another known strategy tool is the McKinsey 7-S model. This is an effective aid to understanding the factors that make up an organisation, how they interact and how changing one element has a knock-on effect on all the others. This model is based on the assumption that there are seven key elements that have to be considered if an organisation is to be understood, these being strategy; structure; systems; staffing; skills; style and shared values.

Whilst the models described above can be effective in some environments, there is nevertheless a need for a strategy model that is more responsive than those presently available.

An object of the present invention is to overcome one or more of the problems associated with the prior art.

### SUMMARY OF THE INVENTION

According to the present invention, there is provided a strategic planning method that comprises selecting and monitoring a business strategy; selecting and monitoring an operational action plan; monitoring real-time critical assumptions and monitoring staff performance. At regular intervals each of the monitored business strategy; operational action plan; real-time critical assumptions and staff are reviewed. Once this is done, any one of the business strategy; the operational action plan; the real-time critical assumptions and staff data is up-dated.

Preferably, the step of reviewing is conducted at a single review meeting. The step of reviewing is preferably conducted once a week.

An advantage of this method is that information on various inter-related business functions can be gathered together, monitored and reviewed in a systematic, organised manner. This means that a company can be made aware of and respond easily and quickly to changes, whether the changes be to the operational plan or to real time critical assumptions.

Preferably, the method involves testing the real time critical assumptions and using results of the testing in the review of these assumptions. An advantage of this is that the reliability of the assumptions can be verified. In the event that the assumptions are no longer valid, action can be taken as part of the review process to ensure that the real time assumptions reflect as far as is possible market reality.

The business strategy may be based on a Balanced Scorecard approach.

The step of monitoring staff performance may use key performance indicators. The step of monitoring staff performance may use a key result area approach.

The step of reviewing may involve identifying and monitoring one or more of a companies' strengthens and weaknesses. The step of reviewing may involve monitoring and categorising data according to its perceived accuracy and reliability.

The method may further involve setting a predetermined condition, which if met triggers the step of reviewing.

### BRIEF DESCRIPTION OF THE DRAWINGS

A method in which the invention is embodied will now be described by way of example only and with reference to the accompanying drawings, of which:

FIG. 3 is a block diagram that shows various inter-related business functions;

FIG. 4 is plot of the number of people in a company in agreement vs time for two different statements;

FIG. 5 is typical plot of the number of managers in a company in agreement vs time, for two different statements, when the company outlook is optimistic, and

FIG. 6 is typical plot of the number of managers in a company in agreement vs time when the company outlook is pessimistic.

### DESCRIPTION OF A SPECIFIC EMBODIMENT

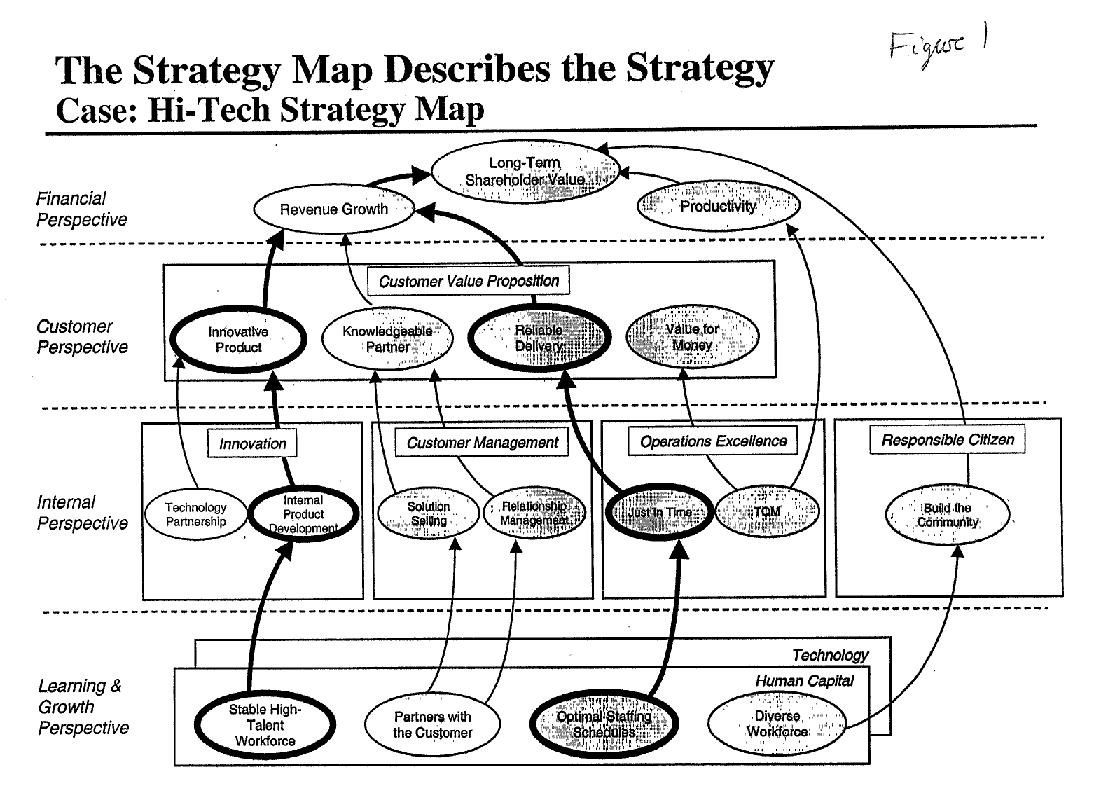

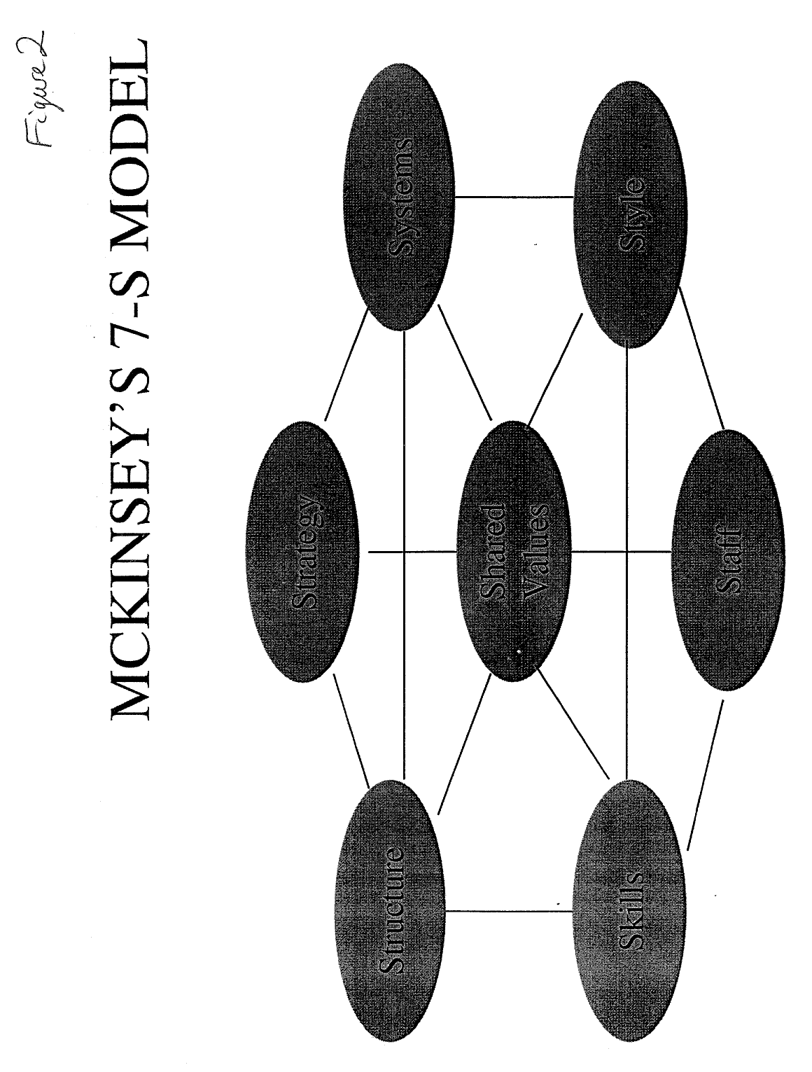

FIG. 3 shows various areas of activity that contribute to the new business method. The method involves the continuous monitoring and review of the core business strategy; the operational action plan; any monitoring activities; any real-time critical assumptions; testing facilities and staff. Each of these is discussed at a strategic, tactical opportunity review meeting (STORM), which is ideally held, say, once a week, or whenever an event occurs that triggers the need for a major re-think of the strategy.

The STORM is the central focal point for all the data internal and external to the organisation. The STORM is a meeting that involves both prior and post meeting work. STORM utilises people and expert systems that interact with advanced thinking support tools. The objectives of the STORM are to act as an information clearing house; monitor strengths and weaknesses; identify and assess opportunities and threats; commission research and other test activities; recommend changes to strategy, operational or tactical plans; monitor performance and analyse data; communicate and action and police changes

Segmenting information into Fact, Faith or Fiction, i.e. acting as an information clearing house, is one of the key roles of the STORM. The aim is to take data and by analysis generate information, combine this information in the STORM to produce market intelligence then add this intelligence to management's expertise to produce competitive advantage. For this process to work, the data must be valid and the most important criteria for assessing the validity of data are: its source, its consistency, its trend over time, and corroborative information. During the STORM meeting, this information is filtered, distilled, interpreted and analysed, turning it into market intelligence upon which decisions can be effectively made.

The STORM, like any decision process reliant on research information, is not immune to Type One and Type Two error. For this reason, decisions are logged and monitored and if necessary, tested to verify data accuracy using primary research surveys. Type one error “Fact taken as Fiction error” and type two error “Fiction taken as Fact error” is present in any system which has a degree of uncertainty present. If action is taken on information, believing it to be true, when it was fiction then a type 2 error is committed. Where market intelligence is ignored because it is believed to be fiction when it was fact then a type 1 error is committed.

Taking raw data on the journey to knowledge requires constant separation of fact, fiction and faith as data is transferred into information, then intelligence, and finally to knowledge. Knowledge is the category where it can be accepted as fact that there is none or very little possibility of type one or type two error.

In addition to categorising information appropriately, the STORM monitors the weaknesses and strengths of the company. These are assessed, discussed and recorded for comparison at a later date. The issue of what are considered strengths and what are considered weaknesses depends on the environment the company is operating in. While strengths and weaknesses are internal to a company, they are strongly influenced by the market and general business environment: take size as an example. In a small company, size may be viewed as a strength, as a more personal service can be given to customers. However, it can also be considered as a weakness in that it limits the size and number of the contracts taken on, even when demand is growing. In this light, strengths and weaknesses should be monitored and if the strategy favours rapid growth, then current size becomes a weakness. If, on the other hand, the strategy is organic growth through a secure loyal customer base, size becomes one of the organisation's strengths.

During STORM meetings strengths and weaknesses are classified correctly in the changing environment. What at first is one of an organisation's strengths can, because of the market or environment, become a weakness overnight. For example, being a dot.com company in 1999 was a major strength in getting financial investment, while in 2001, being a dot.com is a positive hindrance in gaining investment. Constant checking ensures that the relative strengths are growing while the weaknesses are being eliminated and that both are classified correctly.

In addition to the weaknesses and strengths of the company, the STORM constantly monitors the market for opportunities and threats. In this way, appropriate action can be taken to secure the best opportunities and there is time to deal with the threats or even transform them into opportunities. This constant monitoring is advantageous because, what at first appears to be a threat can be a major opportunity. As with strengths and weaknesses, opportunities and threats need to be monitored in real time and the STORM meeting is used to filter and sort the data into market intelligence.

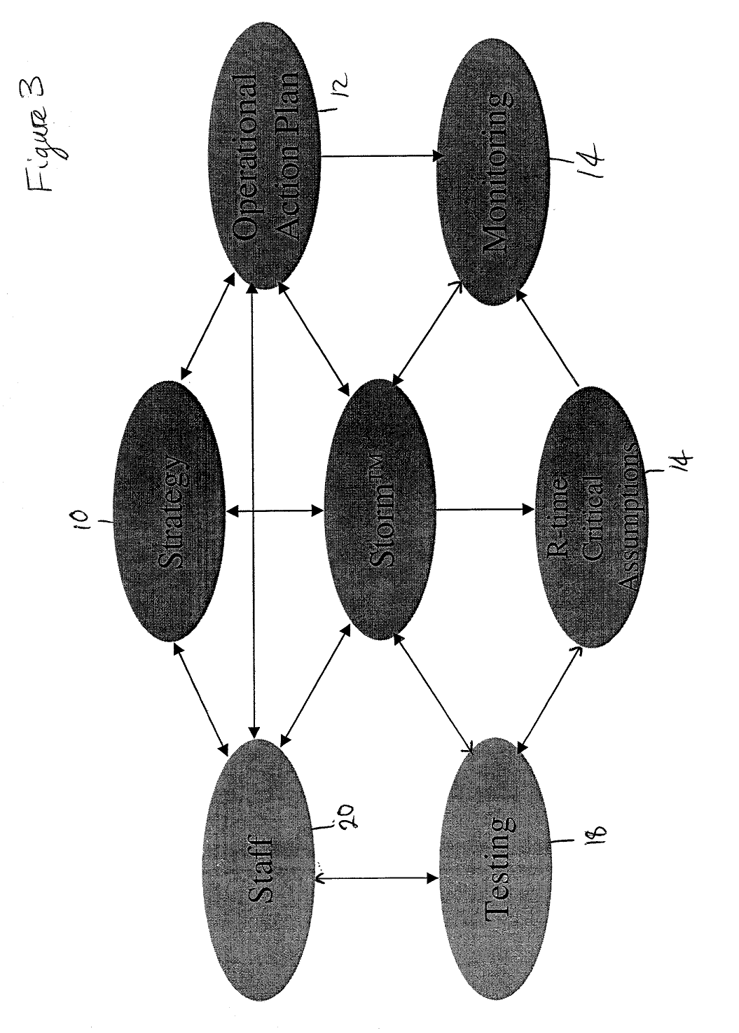

In order to be sure just what is important and represents an opportunity, what is being looked for has to be identified. There are, in any large organisations, a great number of differing views, about what represents an opportunity or a threat. Opportunities tend to break down into three groups: the “obvious opportunity”, the “grey area”, and the “obviously not an opportunity”. This is illustrated in FIG. 4.

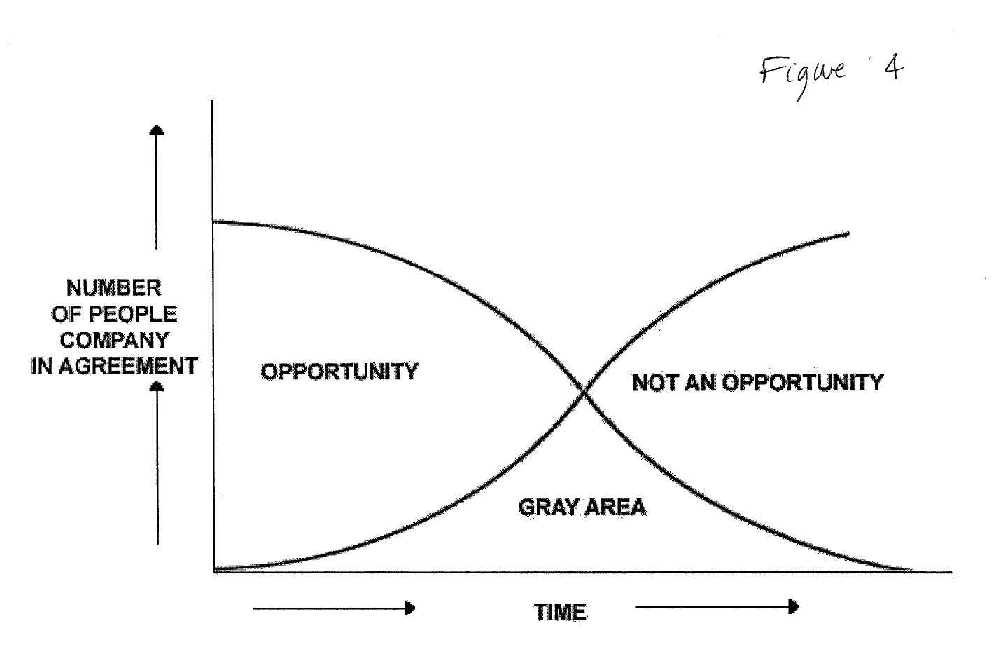

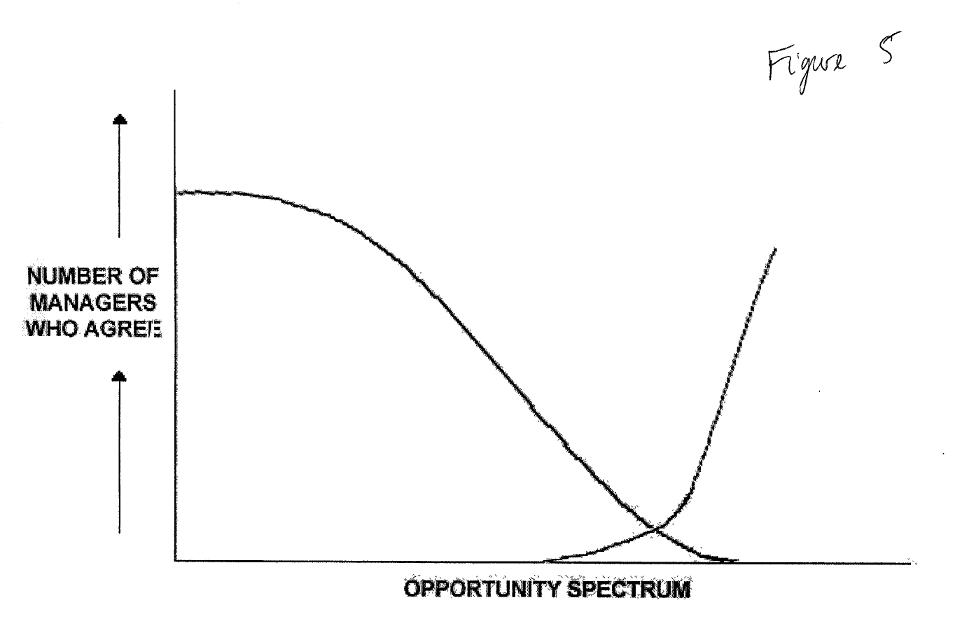

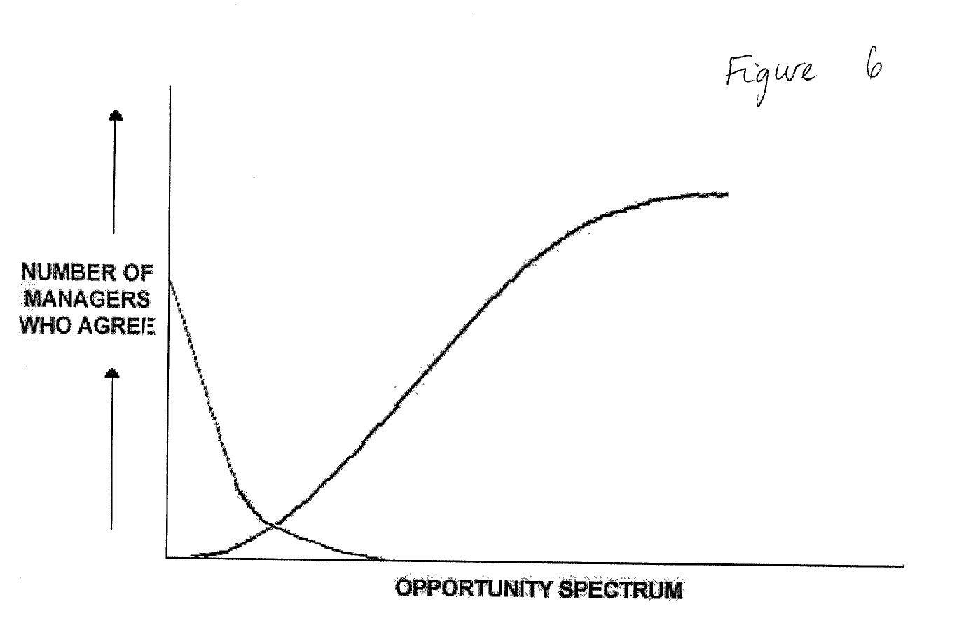

Some opportunities are so obvious that if a census of a company were to be conducted, everyone would agree it is an opportunity. Likewise there are some things that everyone in the company would agree are not an opportunity. Unfortunately, in the vast majority of situations there is some level of disagreement as to whether the information represents an opportunity or not. There are a number of factors that contribute to this problem. The more entrepreneurial the attitude is in the company, the more skewed the diagram is to the left, as shown in FIG. 5. The more pessimistic the outlook, the more skewed to the right, as shown in FIG. 6.

The STORM meeting has to interpret the opportunity and learn to whom it is relevant and in what circumstances. This can be done using Neuro-Fuzzy logic modelling. Opportunities can be assessed, the number reduced to a manageable size, and the relevance of each prioritised by the computers.

One of the most significant aspects of the STORM is its ability to identify a paradigm shift. By monitoring emerging technology and by modelling the impacts of changes on the current paradigm, it is possible to identify threats posed before the new innovation has swept into the market. This allows time to develop competitive technology or even to acquire the new technology.

In the real world things are not often clear-cut, usually information is vague or incomplete. There is therefore a need to commission research to clarify information or verify assumptions. The STORM function prioritises and commissions such research. The full spectrum of research techniques may need to be applied or just a simple test but what is required and how best it should be done is determined in the STORM.

If a critical assumption, upon which the strategy is based, is compromised it may necessitate a modification to the strategy or it may not. One of the most likely compromises is that the strategy assumes a growth rate based on sales. If the sales are not made, this has only one of two possible causes. The objectives are set too high and it is impossible to achieve the sales forecast or, the company has failed to perform at the operational or tactical level. If the fault lies at the operational or tactical level, then the problem must be identified and new tactics applied in order to get the sales back on track. If the fault is at the strategic level then there is a more serious issue.

STORM involves dynamic forecasts, monitoring of performance, analysis of data and testing of assumption and scenarios. NeuroFuzzy applications can be used. These are fuzzy logic systems combined with neural net technology. These applications can process data that is not precise, learn from the results and then do better the next time the same fuzzy pattern is identified.

As is well known, fuzzy logic technology mimics the human decision making process and allows computers to accept natural human language while neural nets imitate the way the brain learns to some extent. An advantage of this is that unlike traditional expert systems, which can only be operated using “hard” data (True or False), fuzzy systems can work on terms like “sometimes”, “almost”, “likely”, “pretty much”. This means that these systems can deal with the uncertain nature of partial information or incomplete data. This is an advantage.

When some forecasts are met but others are not, this type of system is able to handle, more like the human brain, the uncertainties. A result of this is that it can deal with the more abstract issues like “almost reaching” budget rather than the they did or did not achieve of the typical computer software. This means that rather than issuing an alert because a number is 999.99 and not 1000 for example, the system accepts an “almost” range learned what short fall is significant and how likely it is to impact the company's critical assumptions.

While fuzzy logic systems can handle large volumes of data and reduce it to a manageable size, humans are vital in the STORM inter-phase. They are the strongest link but they are also the weakest. STORM allows humans to do what they are good at: seeing patterns and linking information to form intelligence. They can put one and one together and generate 25. The human can deal with Faith, handle weightings better and deal with the first exposure situation better than any computer system.

Another function of the STORM is to control communication and ensure that relevant information is given to the right person. Knowing what is happening and which scenarios are developing is of little value unless this information can be communicated to those who will be tasked with taking some kind of action. Therefore, Enterprise Neural Trails (ENTs) have to be developed so that who needs to be informed is known—not such an easy task in a large global company. The ENTs have to be built and kept current. This is a job that falls, in part, to the personnel function.

In rapid growth companies, staff recruitment can be at a frantic pace and the staff roles and responsibilities seem to change almost daily. This is difficult to keep track of even for well run personnel functions, who may know who they employ and what they were originally employed to do but have not managed to track the changing of staff duties after recruitment. Also, as priorities change, some functions become less important and get relegated to the organisational mist.

In rapidly changing environments and when multiple initiatives are running in an organisation, what gets measured is what gets done. Therefore, it is necessary that the actions required to be done are carried out and that the plan for change is vigorously policed. The STORM provides the feedback on the progress of change implementation. Many initiatives in a company fizzle out before achieving their goals. The problem is that with so many priorities and heavy workloads, tasks with a strategic tag tend to get less attention and are often pushed off the agenda. Thus, the long-term adjustments needed don't get implemented quickly enough and the forecast situation the plans aimed to avoid overtakes the organisation.

Returning to FIG. 3, it can be seen that round the STORM is a core collection of functional GMAS modules. These modules include strategy 10; operational action plans 12; monitoring 14; real-time critical assumptions 16; testing 18 and staff 20.

The strategy module 10 is used in the preparation of the initial strategic plan and is responsible for keeping the plan continuously up to date. This includes all scenario planning and modelling functions. The strategy and associated strategic plans, whether fed throughout the organisation by Balanced Scorecard software or in a key performance indicator system, has to be monitored and particular attention paid to the associated critical assumptions. The way the plan is being implemented must be monitored against the staged milestones. The easiest way of ensuring the strategy is kept in mind is by using some kind of dashboard or Balanced Scorecard system. Software products are currently available to help in this area.

Strategy 10 alone cannot do anything. It has to be effectively translated into operational plans 12 and it is these that lead the company to the achievement of its mission. These plans must be as flexible as possible but also be bound by the strategy. Therefore, the monitoring and testing of operational plans 12 is a major source of data to the STORM. This information can be provided by reports produced by Customer Relationship Management, Enterprise Resource Planning or Balanced Scorecard software as well as other management information systems. This combined with ENT allows the quality of the data being derived from these systems to be assured.

Strategy 10 is an output from a process and is only as good as the inputs upon which it is based. Therefore, senior managers are the facilitators and communicators of the strategy and not its protectors. The strategy protects itself by working. If operational managers ignore the strategy to achieve the targets, the company is directionless and drifting. The marketing messages will be conflicting with the operational reality, marketing positioning the organisation in one way while operations is delivering something else; often developing other sales channels at a complete tangent to the company's goals and public statements. Before long the operational reality becomes known and the credibility of the senior management is lost. To prevent this, in the method of the present invention, critical assumptions are monitored and regularly re-assessed to determine whether they are Fact, Faith or Fiction. In this way, opinions are modified as the plan is executed and the results become known.

Just as significant as the operational plans being aligned with the strategy and vice versa, is staff being involved in the on-going planning process. This means that staff should have “strategy influencer” added to their job description. The opinions and information provided by staff, influence strategic thinking. This does not create an organisation that simply becomes completely opportunistic but it does give the organisation the option to be flexible if it so chooses. By being aware of the options, the organisation can choose to take those bringing it closer to its goal and ignore those who don't.

Each of the staff must know where they fit into the organisation and the achievement of the mission. The traditional way, based on performance management models, is the KPI and/or KRA models.

A Key Result Area (KRA) is where an individual needs to focus attention and which success will build with co-worker's success to achieve the organisations objectives and associated mission. These KRAs are broken down to Key Performance Indicators, which are in effect “SMART Objectives” as these performance standards should be Specific, Measurable, Achievable, Realistic-results-oriented and Time encapsulated. Dale Carnegie® Training provides very good training courses to help phrase a KPI. They suggest starting the sentence that encapsulates the KPI with: “My job, in this area, will have been satisfactorily performed when,”.

An example of a KRA and a few related KPI for a Quality Control Manager, could be as follows: Mission Element—To produce products that don't come back for customers that do come back; Related KRA: To manage the quality function and ensure we provide products that don't come back for customers that do; Single element KPI: My job will have been satisfactorily performed when the monthly total of RMAs (Returned Material Authorisation) has dropped to less than 1% of dispatches. Usually, there would be several KRA's related to achieving the mission element and for each KRA there would be several KPIs.

There are a number of ways of linking the KRAs to the business strategy ranging from Balanced Scorecard software to Dale Carnegie's® paper based KRA system, to simple systems provided by Knowledge Point that are available in most software stores. Whichever method is chosen, the important point is to keep it current and monthly KRA meetings are recommended to provide the evidence of KPI being met or being on route to being met. The KPIs must be monitored, as they are critical to the achievement of the company's mission and act as a leading indicator of emerging problems.

Reviewing the performance of all staff on a monthly basis may sound excessive, but they are the most expensive and valuable assets of the company. KRA systems maintain the asset at peak performance. Automated reporting and KPI measured from secondary sources means that there is no need for this to become a huge time intensive exercise or to become too subjective. Imagine the alternative: if things are not well, waiting twelve months for an appraisal could kill the company. Just think how much damage can be done by a “malfunctioning employee” in twelve months and with no record of performance in many, especially European, countries poor performers can be extremely expensive to remove. If objectives are not being met because the wrong people are in place then just like having the wrong equipment, the company will suffer and in the end this failure to manage all the assets in achieving the mission will bring the company to a crisis point.

As the strategy changes or is modified as a result of market reality then the KRA and KPI change also. Whichever method is adopted for the management of KRA and KPI, it should be flexible and easy to re-focus and that no backwaters are allowed to develop.

The Enterprise Neuron Trails (ENT) run throughout the organisation and follow the KRA and KPI trails. They provide the rapid response to market stimulation and are inclusive of all staff in the organisation. The personnel department should maintain the ENT system. It is easy, especially in companies experiencing rapid change, to lose track of who is actually doing what and for critical things to be dropped in favour of less onerous or “nice to do” activities. Most organisations have procedures to stop this kind of thing but are they current and does everyone know about them? As takeovers and mergers get larger, keeping track of who is doing what vital job is going to become increasingly complex. Having a live ENT system ensures that senior management can be confident that everyone in the organisation is working to achieve the mission and that, as changes are required in the strategy, backwaters where resources are being squandered are not being formed within the company.

Another important function of the method in which the invention is embodied is to monitor any critical assumptions 16 that are made in the business as a whole and specifically in the strategic planning process. These critical assumptions 16 have different priorities. Some are so important that they must be tested immediately, while others are nonetheless critical but probability theory or a strong “Faith” permits them to be monitored or tested if time permits only.

Critical assumptions 16 have to be expressed and gathered with care. Resources have to be spent to monitor them in real time. Because of this it is important to distil them down to a concentrate that can be manageably monitored preferably in real time. While monitoring critical assumptions 16 in real time is important, it is equally important to only report them at the right time. If every market fluctuation or analyst's off the cuff comment is taken as Fact then STORM meetings would be triggered daily in any sizeable organisation. To avoid this, a technique from quality assurance has been borrowed. Frank Price back in 1984, published a book entitled “Right First Time”. A meeting should be called when a critical assumption 16 has really been challenged, but not when it is a result of our research only suggesting a problem. The risk of making the wrong decision is increased by inadequate knowledge, therefore the more irrefutable the data the more knowledge and hence, better market intelligence can be gathered. In order for the right decisions to be made, reporting every research discovered anomaly is not going to be useful, but reporting too late is equally of no use. Therefore, a boundary has to be set, which if exceeded by the real-time data, it triggers a STORM.

Boundaries in quality assurance can be set by employing a statistical process control, in which an action and warning limit is pre-determined. These boundaries of tolerance prevent false alarms being caused by background noise but trigger a warning (calling a STORM meeting) and action required (where the probability of the critical assumption 16 having been compromised is very high and action is required). In a similar way, critical assumptions 16 being monitored in real time have boundaries that must be exceeded for a STORM meeting to be called and limits where a compromise of a critical assumption 16 is almost a Fact.

Where there are multiple leading indicators, Fuzzy logic allows a combination of indicators approaching a predefined limit to trigger a STORM meeting and in some cases to not call a meeting even when one of the indicators exceeds its limits while the others remain well within the expected range.

As an important part of the process, it is important to assess whether critical assumptions set are realistic. Some things could be critical: for example, “an atomic bomb could be dropped on our Glasgow office”, but it has such a low probability and there are so many other factors that would then come into play that it is not realistic to log this as a critical assumption 16. While “The market will continue to grow at the same rate of 40% for the next 3 years” can be a realistic critical assumption 16.

Critical assumptions 16 have a life time as well as having an associated time frame. In the example given above, the 40% growth has been framed within three years. After three years, the “sell by date” of this critical assumption 16 will have been reached, and will need to be replaced. Many critical assumptions 16 have review date that provides a point in time that requires the assumption to be verified or measured.

By linking the critical assumptions 16 to KRA and KPI, it is known how the organisation is affected by the critical assumption 16 and who may be in a position to provide leading indicators of this assumption's validity or potential compromise. By leading indicator, it is meant an indication of a market condition that predicts the condition to come. If sales representatives talk to customers and those of our competitors each day, they may be the first to know of a competitor price change or new product release. Hence it is imperative that market intelligence is quickly distributed to those who can capitalise upon it. Each critical assumption 16 should be linked to the ENT system so that a corporate knowledge base can be effectively established and operated.

Critical assumptions 16 have to be measurable in some way. Using fuzzy logic has increased the measurability of many critical assumptions 16 but it is imperative that they can be measured. The measurement approach can, in some cases, be difficult to identify and the more complicated the measurement specifications, the more difficult and unreliable monitoring becomes.

The critical assumption 16 must be explicit because if it is not easy to understand and cannot easily be interpreted, it will be misunderstood and misinterpreted, making it impossible to monitor the true critical assumption 16. Because many of the critical assumptions 16 are derived in creative sessions during the strategic planning process, they are derived with a specific perspective in mind. Even when reread by their creator at a later date, they can be interpreted differently. Similarly, several senior members of the management team can read them differently upon reflection. This ambiguity has to be eliminated and the critical assumptions 16 phrased so that a researcher knows exactly what they mean and can therefore derive the most effective methods of testing or monitoring.

Another important step in the process is monitoring. As with testing, there are a wide variety of critical assumptions 16 and action plans 12 to be monitored. There are two types of monitoring: internal and external. Internal monitoring can be done via a Balanced Scorecard type system or Enterprise Resource Planning system and this means that it can be done in a very complex manner or in a simple way using weekly reports. The complexity is greatly reduced when it is quite clear what is important to monitor.

External monitoring can utilise tools such as almost fully automated Fuzzy logic based systems to search Internet based news feeds and web based customer research through to simply scanning through the Financial Times each day. Press Monitoring covers 80-90% of press publications relevant to the specific sector your company operates within. The Financial Press such as Financial Times, Wall Street Journal, The Australian Financial Review and Handelsblatt are a rich source of business news, stock analysis and expert opinion. National newspapers such as USA Today, The Times, The Australian, the Japan Times and Die Welt contain good local country coverage and are especially relevant when consumer markets are being targetted. Local, Citywide or Regional newspapers such as New York Times, Chicago Tribune, and Houston Chronicle, The Herald, are important as many global companies have their headquarters within the area. They provide a good deal of local information that can be significant and cover local news in-depth. In addition, these publications tend to know about planning applications well before the national newspapers. They can also be good barometers of local feeling towards a project. For example, the local Silicon Valley and San Jose Business Journal indicated support for a new power plant to be built in the city even when covering local pollution concerns. This allowed the IPP (Independent Power Producer) to judge the mood and successfully negotiate the legislative and political barriers. Weekly publications such as Business Week, Time, Newsweek and The Economist are also worth monitoring weekly as they contain an in depth analysis of industry sectors and countries.

Press Monitoring is a rich source of information but it has to be borne in mind that it is not always accurate and the growth in PR and investigative journalism can produce a confusing picture. necessarily more authoritative.

In addition to the general press, trade journals and periodicals are a vital source of news and information concerning the industry sector they represent. These journals contain detailed articles, expert commentary and report trends very accurately. Journals are widely read and the information they contain is known to most in the industry and as these publications are often monthly, the news they report can be old. The Internet versions are more up to date and can be a valuable source to the agile company who can act on the information quickly. They are usually fairly authoritative and outside their “advertorials”, (Articles that an advertiser is paying for) and the “article for advertising” (the inclusion of a news article given to an advertiser) they can provide genuine insight. The better journals tend to have few advertorials and where they are present, they are clearly marked as such.

Two examples of how information can be utilised with leapfrog promotion. A brewer in Britain went to press with how their beer was now the best selling German beer in the UK, only to have their huge spend nullified by a competitor who, using the same style of advert, simply stated: “You have tried “A”, the best selling German Beer in Britain, NOW try “B”, the best selling German beer in Germany”. One year later they were not only the best selling German beer in Germany but they had also become the best selling German beer in Britain.

In the same industry, an innovation of creating a can that could hold 33% extra had been a winner at the peak selling period of Christmas for one brewery. In their enthusiasm and feeling that the competition would not be able to adjust their production systems, they announced their intention to the trade of repeating the very successful promotion. However, they subsequently found that they could not sell their stock because the competitors had flooded the distribution chain by offering very large bulk discounts. Although the retailers knew they would be able to sell the 33% extra cans easier, they had no room nor wanted to be left with the other brand so chose not to stock it. The 33% extra promotion had been effectively countered by their main competitor. Had they not been so confident to announce their intention, perhaps the competitors would not have acted so quickly to flood the distribution channels.

Web Monitoring is another option. This involves the gathering of news articles and competitive information by using the Internet. For almost all industries, this can prove to be the most popular and productive source of information relevant to a company. Company sites are particularly useful and can be used to obtain information regarding competitors and companies within a particular industry sector. Newsletter sites are also useful. Various market research and web portals cover news dedicated to a particular industry or many industry sectors. These sites are a rich and productive source of latest news and information. Third party, expert and consultant sites cover views, insights, commentary from analysts, organisations and companies and even case studies that can all provide valuable insight. Government sites cover legislation and new regulations that affect all companies equally within any sector. These sites contain federal or ministerial departments, governing bodies and regulators. The freedom of information legislation has made information more accessible. For example, on the US Navy website, presentations by vendors are often posted.

The main advantage of web monitoring is that it can be done in real-time. Information on company and newsletter sites is often constantly updated and is of high quantity. The main disadvantage of web monitoring is the overwhelming amount of information that can be found. All news releases concerning a particular industry may not be important and therefore the vital news has to be filtered and sifted. There are however various software packages on the market that can carry out the filtering and producing information that is needed. The problem with this is that repeated articles can give these systems difficulty in recognising that they have already retrieved the same article from another source. The huge volume of data means that there is also a requirement for considerable computer power. The role of the library should not be overlooked. Libraries like the National Library in Washington and the British Library in London contain copies of a vast array of publications that are often too expensive to even be held by the rare, well-funded, corporate libraries. Some libraries also provide search and research services so that for a fixed monthly fee you can have information relevant to your critical assumptions 16 gathered and reported to you. The main disadvantage of using a library is the time involved in researching and obtaining the information. Public libraries may be free but trained researchers are required if the knowledge they contain is to be harnessed effectively.

TV and Satellite News and current events are also good sources of information. The number of channels dedicated to providing general news and current events, financial and market news on a global basis 24 hours a day is growing. Channels such as CNN and Sky News cover world news as well as world business news and reviews. Reuters have a channel dedicated to providing up to date news online as well as on television. There are specialist channels such as Bloomberg and CNBC that purely cover business and stock exchange news, company and industry reviews and interviews with CEO's.

As well as monitoring activities some critical assumptions 16 and plans need to be tested. Testing is split into two. The Red area (Urgent and Important) is where action is taken during the planning process while the strategy teams are still in place and this is frantic and exciting. Tests are devised and executed often within days; results are back quickly and are being used in the following planning meetings. There is a great deal of debate over the findings and plans are built upon the results.

Non urgent (Blue) items although important, are logged for testing at some future date. The excitement of the planning phase over, they are scheduled for testing during the life of the plan or testing is not considered as monitoring is considered sufficient. This testing or marketing research often utilises a wide spectrum of research techniques. It is imperative that the test programme is policed and that senior management back the test programme even when things appear to be going well. In practice, the better things are going, the less enthusiasm there is for the investigating of critical assumptions that might spoil the moment.

Many of the monitoring and testing functions of the method in which the invention is embodied can be conducted using computers, although it will be appreciated that this is not essential. Indeed, it is estimated that given the right systems about 80% of the inventive method can be automated to monitor and review the business strategy; the operational action plans 12; the real time critical assumptions; market intelligence and staff performance. However, 20% of the work still has to be done during a core STORM meeting. The strategic planning team selected to attend this meeting should preferably comprise a first group of people who tend towards being perfectionists and have an eye for detail and a second group of visionaries who can “think out of the box”. It is also important to ensure that the people involved in the STORM meetings are those with an existing depth of knowledge about the industry and especially the company. They should have experience in the company, have a positive attitude and above all an open mind.

STORM meetings have to be conducted weekly by the strategic planning team. Where consultants are being used, these meetings may not require the client to be present. Clients may wish only to have a weekly report delivered to them but if they do, they must be prepared to be called in when a critical assumption is being compromised. This is because no matter how familiar a consultant becomes with an industry, they will never manage to match the experience and understanding of the someone working day to day in that industry.

It is therefore better if staff can at least observe at the weekly STORM meetings if consultants are used. Even if the system is run in-house, staff members should be invited to attend and contribute to the process. However, knowledge brings power and those who seek power often want to attend all these meetings and the STORM must not become involved in company politics.

The STORM is a necessary activity that involves the strategic planning team in making decision and providing the human inter-phase with the various data inputs. It effectively replaces the strategic planning cycle, providing smaller inputs to strategy, rather like an autopilot in an aircraft keeping the plane on course and avoiding the need for major control movements. The majority of events result in no or only minor strategic changes being required while paradigm shifts can be detected and exploited. The fundamental ability to investigate, early variations from plan allows errors in execution to be corrected while the synergy from combining operational, tactical and strategic intelligence provide robust and aligned strategic, operational and tactical plans. This generates a strategically aligned and focus organisation that lives the strategy because it is relevant throughout the organisation.

There are many advantages of the new strategy method system described herein. For example, because a company using this method can deliver more often on its promises and be more accurate in its planning and forecasting, this inevitably increases stock holder value. In addition, because the company has a better situational awareness of market conditions, which it can exploit at the right time and sooner than competitors using a traditional planning cycle, this means that sales can be increased. This is coupled with the ability to continuously monitor the market opportunities. Furthermore, by understanding the market better and by having a more flexible strategy model, profit opportunity can be maximised. This is advantageous.

By identifying and acting upon natural paradigm shifts, customers' satisfaction can be ensured by providing them with products and services that meet their current as well as future requirements. By making smaller changes to strategy, more frequently, major changes are avoided and there is much less fear in the organisation.

The method in which the invention is embodied provides a clear and simple view of strategic planning in turbulent markets. When combined with existing systems or simply implemented alone, this method provides a framework for a “real time right time” strategy that responds to market reality and can distinguish between operational and strategic errors. Thus, it offers increased stakeholder value, cost effective implementation, and enhancement of existing investments in enterprise systems. This is advantageous.

A skilled person will appreciate that variations of the disclosed arrangements are possible without departing from the invention. Accordingly, the above description of specific embodiments is made by way of example only and not for the purposes of limitation. In particular, it will be clear to the skilled person that minor modifications can be made without significant changes to the methods described above.

1. A strategic planning method that comprises:
monitoring a business strategy;
monitoring an operational action plan;
monitoring assumptions;
monitoring staff performance;
reviewing each of the monitored business strategy; operational action plan; critical assumptions and staff performance; and
up-dating any one of the business strategy; the operational action plan; the assumptions and staff performance in response to the step of reviewing.

2. A method as claimed in claim 1, wherein the step of reviewing is conducted at a single review meeting.

3. A method as claimed in claim 1, wherein the step of reviewing is conducted once a week.

4. A method as claimed in claim 2, wherein the step of reviewing is conducted once a week.

5. A method as claimed in claim 1 further comprising testing the assumptions and using results of the testing in a review of these assumptions.

6. A method as claimed in claim 1, wherein the assumptions are critical assumptions.

7. A method as claimed in claim 1, wherein the business strategy is based on a Balanced Scorecard approach.

8. A method as claimed in claim 2, wherein the business strategy is based on a Balanced Scorecard approach.

9. A method as claimed in claim 3, wherein the business strategy is based on a Balanced Scorecard approach.

10. A method as claimed in claim 1, wherein the step of monitoring staff performance uses key performance indicators.

11. A method as claimed in claim 2, wherein the step of monitoring staff performance uses key performance indicators.

12. A method as claimed in claim 1, wherein the step of monitoring staff performance uses a key result area approach.

13. A method as claimed in claim 2, wherein the step of monitoring staff performance uses a key result area approach.

14. A method as claimed in claim 3, wherein the step of monitoring staff performance uses a key result area approach.

15. A method as claimed in claim 1, wherein the step of reviewing involves identifying and monitoring one or more of a companies' strengthens and weaknesses.

16. A method as claimed in claim 2, wherein the step of reviewing involves identifying and monitoring one or more of a companies' strengthens and weaknesses.

17. A method as claimed claim 1, wherein the step of reviewing involves monitoring and categorising data according to its perceived accuracy and reliability.

18. A method as claimed claim 2, wherein the step of reviewing involves monitoring and categorising data according to its perceived accuracy and reliability.

19. A method as claimed claim 1 further comprising setting a pre-determined condition, which if met triggers the step of reviewing.

20. A method as claimed claim 2 further comprising setting a pre-determined condition, which if met triggers the step of reviewing.

21. A method as claimed claim 3 further comprising setting a pre-determined condition, which if met triggers the step of reviewing.

22. A method as claimed claim 4 further comprising setting a pre-determined condition, which if met triggers the step of reviewing.
